(19) United States
(12) Patent Application Publication
(10) Pub. No.: US 2015/0062234 A1
(43) Pub. Date: Mar. 5, 2015

(54) COLOR MIXING INSPECTION METHOD, COLOR MIXING INSPECTION APPARATUS AND PRINT APPARATUS

(71) Applicant: CANON KABUSHIKI KAISHA, Tokyo (JP)

(72) Inventors: Hiroyuki Wada, Machida-shi (JP); Tetsuro Yasukawa, Ichikawa-shi (JP)

(21) Appl. No.: 14/473,273

(22) Filed: Aug. 29, 2014

(30) Foreign Application Priority Data
Sep. 5, 2013 (JP) 2013-184309

(51) Int. Cl. B41J 29/393

(52) U.S. Cl. CPC B41J 29/393
USPC 347/19

(57) ABSTRACT

To provide a color mixing inspection method, a color mixing inspection apparatus and a print apparatus capable of carrying out a color mixing inspection at low cost for the inspection with high detection ability. To that end, an evaluation pattern is irradiated with light having a color complementary to color mixed into the evaluation pattern to emphasize the color mixing and measure lightness, thereby determining the presence of color mixing.

### BACKGROUND OF THE INVENTION

1. Field of the Invention

The present invention relates to a color mixing inspection method, a color mixing inspection apparatus and a print apparatus in which a predetermined evaluation pattern is formed on a print medium such as paper and a film to inspect the presence of a color mixture by means of the evaluation pattern.

2. Description of the Related Art

Three types of methods as follows has been known as exemplary methods for ejecting ink from an ink jet print head (hereinafter simply referred to as a print head) mounted in an inkjet printing apparatus; more specifically, a method using an electromechanical converting body such as a piezo element, a method in which ink generates heat by irradiation of electromagnetic wave, such as a laser, so that the heat operates to eject the ink droplets, and a method in which ink is heated by an electrothermal conversion element having a heating resistor so that ink droplets are ejected by the action of film boiling.

Of these, a print head using an electrothermal conversion element is provided with an electrothermal conversion element in a printing liquid chamber, to which an electric pulse which is a printing signal is applied to generate heat so as to impart thermal energy to the ink. Then, a change in phase of a printing liquid occurred at that time brings the printing liquid to a boil to produce a foam pressure which is utilized to discharge the ink liquid from a tiny ejection port, thereby executing the print on a print medium. A color print head using an electrothermal conversion element generally has a group of ejection ports for ejecting ink droplets of each color, and ink channels for supplying ink to the group of ejection ports.

Furthermore, a print head includes a tank replacing type in which an ink tank and a print head are removable from each other, a head cartridge type in which a print head are integral with an ink tank container containing ink, and so on.

A method for manufacturing such as a print head includes a step of inspecting color mixing which evaluates the tone of the ink droplets ejected on the printing medium. This is for inspecting the presence of color mixing of ink generated due to a malfunction inside the print head. Conventionally, such a type of color mixing inspection has generally drawn a pattern for evaluation on the print medium so as to make a visual inspection by an inspector.

Furthermore, a method disclosed in Japanese Patent Laid-Open No. 10-151753 (1998) has been known as a method of detecting color mixing in an ink jet printing apparatus, for example. In accordance with this method, each basic color is printed on a print medium, and reading means reads the printed. Comparison means compares the read result with the acceptable range of tone of each basic color to determine whether or not the tone as a result of printing is normal.

However, the evaluation by an inspector varies depending on variations among individual inspectors who provide an evaluation, and also coming from not being able to conduct a quantitative evaluation. Also, the cost increases because it is a manual operation. Furthermore, the method for detecting mixing color in the ink jet printing apparatus described above may erroneously determine color which is not mixed color as being mixing color because the change in tone may be generated due to overlapping ink droplets ejected on a print medium, ejection failure, change in the amount of ejection, etc.

### SUMMARY OF THE INVENTION

The present invention has been accordingly made in view of the problems described above, and the purpose thereof is to provide a color mixing inspection method, a color mixing inspection apparatus and a print apparatus capable of carrying out a color mixing inspection at low cost for the inspection with high detection ability.

To that end, a color mixing inspection method according to the present invention inspects an evaluation pattern printed by a first color as a reference for the presence of color mixing of a second color other than the first color, the color mixing inspection method is provided with an irradiation step for irradiating the evaluation pattern with light having a third color complementary to the second color in which color mixing is supposed to be generated; and a lightness measurement step for measuring lightness of the evaluation pattern which is irradiated with the light, wherein it is provided with a determination step for determining the presence of color mixing by comparing the lightness measured at the lightness measurement step with a predetermined threshold value.

According to the present invention, an evaluation pattern is irradiated with light having a color complementary to a color mixed into the evaluation pattern so as to measure the lightness, thereby determining the presence of color mixing. This makes it possible to realize a color mixing inspection method, a color mixing inspection apparatus and a print apparatus capable of carrying out a color mixing inspection at low cost for the inspection with high detection ability.

Further features of the present invention will become apparent from the following description of exemplary embodiments (with reference to the attached drawings).

### BRIEF DESCRIPTION OF THE DRAWINGS

FIG. 1 is a diagram showing a structure of a print inspection apparatus to which a color mixing inspection method according to the present invention is available;

FIG. 2A is a plan view showing a front surface of an element substrate having an electromechanical converting body;

FIG. 2B is a plan view showing a rear surface of an element substrate having an electromechanical converting body;

FIG. 3 is a flow chart showing a flow of the color mixing inspection method;

FIG. 4 is a diagram schematically showing an evaluation pattern;

FIG. 5 is a diagram of hue circle that is standardized by JISZ8721;

FIG. 6A is a schematic diagram at the time of measured by means of a color mixing inspection method;

FIG. 6B is a schematic diagram at the time of measured by means of a color mixing inspection method;

FIG. 6C is a schematic diagram at the time of measured by means of a color mixing inspection method;

FIG. 7 is a flow chart showing a flow of a color mixing inspection method;

FIG. 8A is a diagram schematically showing a specific example of the color mixing inspection method;

FIG. 8B is a diagram schematically showing a specific example of the color mixing inspection method; and

FIG. 8C is a diagram schematically showing a specific example of the color mixing inspection method.

### DESCRIPTION OF THE EMBODIMENTS

### First Embodiment

A first embodiment of the present invention will be described below with reference to drawings.

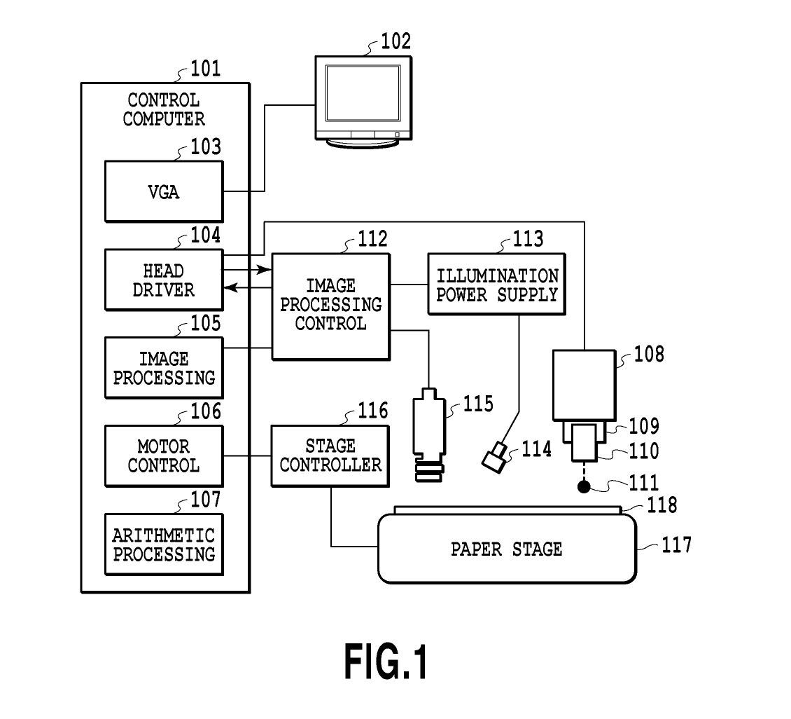

FIG. 1 is a diagram showing a structure of a print inspection apparatus to which a color mixing inspection method according to the present invention is available. A control computer 101 includes an integrated VGA board 103 for outputting on a display, by which an output to a monitor 102 is done.

Furthermore, the control computer 101 includes a head driver 104 for outputting a signal to drive a print head 110 that can eject ink, an image processing unit 105, and a motor control board 106 which are integrated therein and can be collectively controlled. Furthermore, an arithmetic processing 107 is provided inside the control computer 101 so that it is possible to execute high-speed arithmetic processing of an image data taken from the image processing unit 105.

A print signal output from the head driver 104 is converted into a signal tailored to the print head 110 at a print signal conversion board 108 connected to the head driver. The signal tailored to the print head 110 is connected to the print head 110 by a contact probe unit (not shown) through a carriage 109 for attaching the print head 110. This makes ink droplets 111 ejected from the print head 110 land on a print medium 118 to form a printed image.

The print medium 118 is placed on a paper stage 117, and vacuum and the like brings the print medium 118 into intimate contact with the paper stage 117. In the present embodiment, the print medium 118 is used which is coated on the surface so as to be able to uniformly absorb the ink droplets 111 when they lands thereon. The paper stage 117 includes an encoder (not shown) for acquiring stage position information. The encoder is controlled by a stage controller 116 connected to a motor control board 106 inside of the control computer 101 so that an image to be printed properly comes inside the angle of view of a CCD camera 115.

The image to be printed which comes inside the angle of view of the CCD camera 115 can be illuminated by an image processing light 114 connected to an illumination power supply 113, and is taken by the CCD camera 115 to be transmitted as data to the image processing board 105 through the image processing control board 112. In the image processing light 114, an LED light is employed which can output a wavelength of each of R, G and B, and also ensure the durability and the stability of the amount of light. The illumination power supply 113 has an external control terminal which makes it possible to control the amount of light of each of R, G and B under the control of the image processing control board 112.

In the present embodiment, a line sensor type CCD camera is used as the CCD camera 115. The benefit of using the line sensor type CCD is that a high resolution is provided at relatively low cost, and also it is possible to take a necessary part of the image to be printed. This provides an image data which is a high-resolution image while being small in capacity, and thus it is possible to encourage the improvement of processing speed. In addition, an area sensor type CCD camera may be used as the CCD camera 115 as long as the image processing unit 105 has sufficient processing ability to be able to execute high-speed processing.

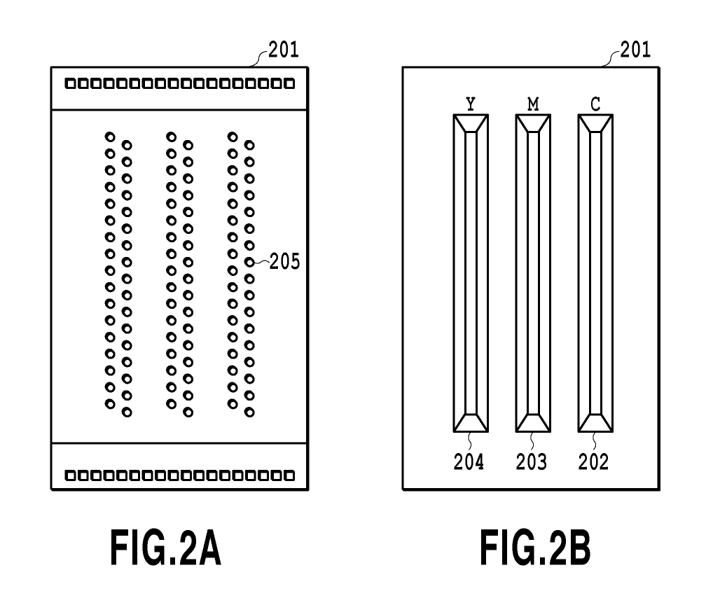

FIGS. 2A and 2B are plan views showing a front surface and a rear surface for explaining an element substrate having an electromechanical converting body. An explanation will be made below regarding the print head 110.

A printing element substrate 201 is a plate 0.62 mm thick which is made of silicon (Si). A plurality of electromechanical converting bodies (not shown) as energy generating element for ejecting ink, and electric wirings (not shown) such as A1 for supplying power to each of the electromechanical converting bodies are formed on one side of the printing element substrate by a film forming technique. Furthermore, a plurality of ink paths (not shown) and a nozzle plate 205 in which plural ink ejection ports are formed corresponding to those electromechanical converting bodies are formed on the printing element substrate 201 by photolithography technique. Along therewith, ink supplying ports 202, 203 and 204 for supplying ink to the plurality of ink paths are formed so as to be opened on the opposite surface (rear surface).

The ink supplying port 202 for supplying ink to the plurality of ink paths is supplied with yellow ink. Then, the ink supplying port 203 is supplied with magenta ink. Furthermore, the ink supplying port 204 is supplied with cyan ink. The ink droplets of three colors thus can be ejected to form a color image.

Due to the structure of the print head as described above, magenta ink supplied to the adjacent ink supplying port 203 may be mixed into yellow ink supplied to the ink supplying port 204 (color mixing is anticipated). Furthermore, yellow ink supplied to the adjacent ink supplying port 204 and cyan ink supplied to the adjacent ink supplying port 202 may be mixed into magenta ink supplied to the ink supplying port 203. Also, magenta ink supplied to the adjacent ink supplying port 203 may be mixed into cyan ink supplied to the ink supplying port 202.

Next, the description will be made regarding a step of inspecting color mixing in the print head for forming a color image which is provided with the printing element substrate 201 described above. In addition, although the structure of the exemplary print inspection apparatus according to the present invention has been described, a color mixing inspection method described in embodiments later is not limited to that for the above-described print inspection apparatus, but is applicable to a printing apparatus such as an ink jet printer.

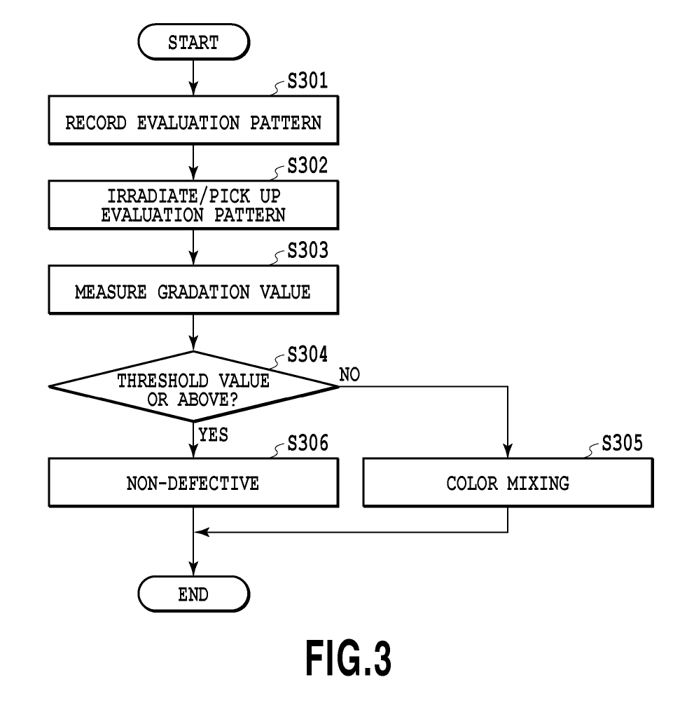

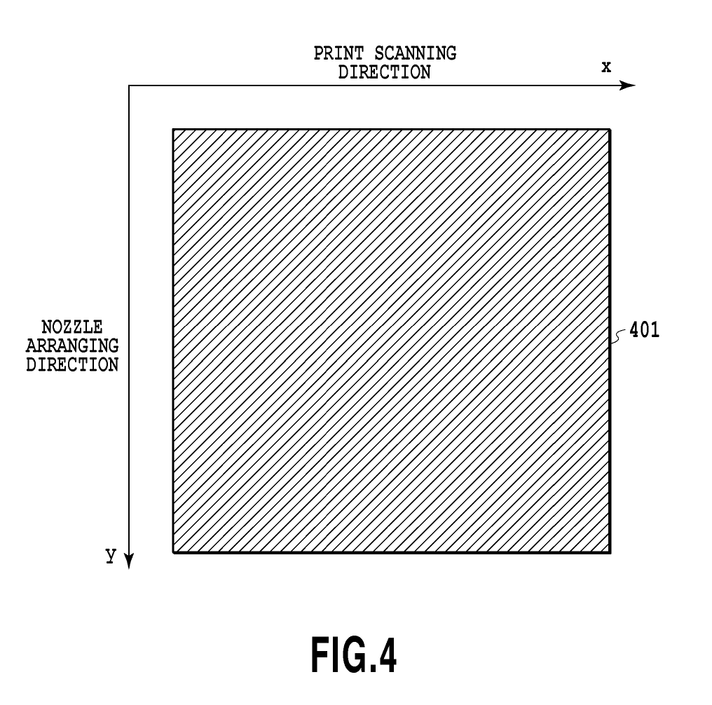

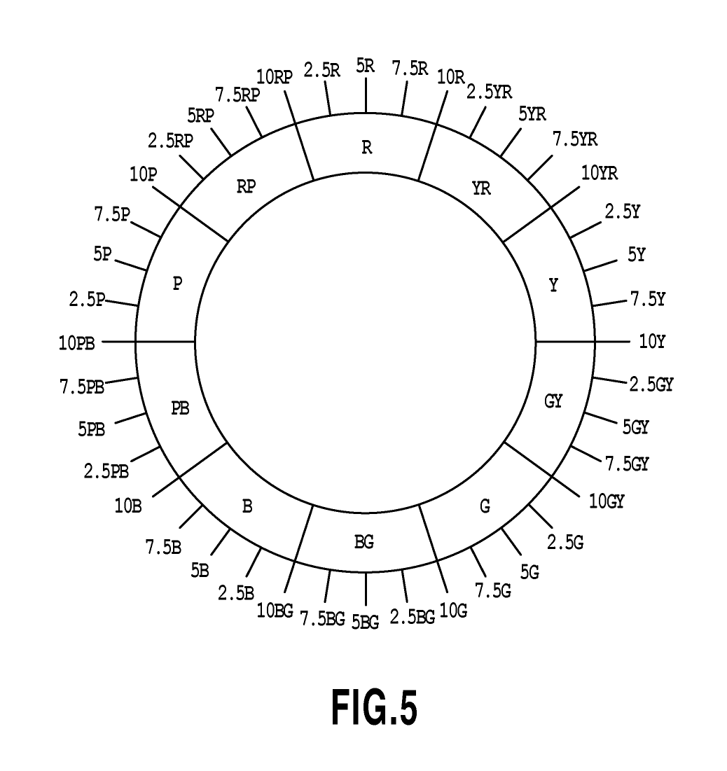

FIG. 3 is a flow chart showing a color mixing inspection method according to the present embodiment. FIG. 4 is a diagram schematically showing an evaluation pattern according to the present invention. FIG. 5 is a diagram of hue circle that is standardized by JISZ8721 (a display method of colors in three attributes), and a hue can be shown by the combination of symbols in the hue circle (R, Y, G, B and P) and numbers (2.5 and 10, etc.). In the hue circle, the symbol “R” indicates red, the symbol “Y” indicates yellow, the symbol “G” indicates green, the symbol “B” indicates blue and the symbol “P” indicates purple.

Furthermore, as the neutral hue, the symbol “YR” indicates yellowish red, the symbol “GY” indicates greenish yellow, the symbol “BG” indicates bluish green, the symbol “PB” indicates purplish blue and the symbol “RP” indicates reddish purple. In general, colors located diametrically opposite to each other in the hue circle are regarded as complementary colors. Since the difference in hue becomes largest in the combination of the complementary colors, the colors complement each other so as to provide an effect that the colors are enhanced each other (complementary color harmony). The color mixing inspection method according to the present invention carries out the inspection for color mixing through the use of complementary color harmony which has an effect on enhancing the colors each other

A color mixing inspection method of the present embodiment will be described below along with a flow chart in FIG. 3. When the color mixing inspection is started, an evaluation pattern shown in FIG. 4 is printed at step S301. At that time, the print head 110 is driven to move the paper stage 117 while ejecting the ink droplets (of first color as being the reference) to the print medium. A speed of the movement of the stage is determined by an ejection characteristic of the print head 110.

In this manner, the droplets are adhered on the print medium to form the evaluation pattern 401. As shown in FIG. 4, the evaluation pattern 401 is a patch pattern of each color printed by driving all the nozzles of the print head, and the printing is implemented for each of single colors in the print head. The present embodiment has employed the print head including three colors, i.e., cyan, magenta and yellow to form the evaluation patterns 401 of each of single colors, i.e., cyan, magenta and yellow.

Next, the evaluation pattern is illuminated by an LED and the image thereof is picked up at step S302. In order to illuminate the evaluation pattern, the evaluation pattern 401 is irradiated with light having a complementary color which is located in the hue circle shown in FIG. 5 diametrically opposite to the color (that is a second color other than the first color) of ink in the ink supplying path adjacent to the ink supplying path of the ink for printing the evaluation pattern. Then, the image picked up in that state is read in the image processing unit 105. At the time of picking up the image, the paper stage 117 carrying the print medium 118 on which the evaluation pattern 401 is formed is moved to a picking-up area of the CCD camera 115. In addition, the speed of the movement of the paper stage 117 is determined by the image picking-up characteristic of the CCD camera 115.

In the present embodiment, when the color of the evaluation pattern is only cyan, magenta is the ink color in the ink supplying path adjacent to the ink supplying path of the ink for printing the evaluation pattern, and thus magenta is the color that will be mixed into cyan. In the hue circle shown in FIG. 5, magenta belongs to the symbol RP and the symbol G is the hue that is located diametrically opposite thereto, so that the evaluation pattern is irradiated with illumination light having a color belonging to the symbol G, which is the color complementary to the symbol RP, so as to pick up an image. The range of hue of the illumination having a color belonging to the symbol G is preferably any of 2.5G, 5G, 7.5G and 10G.

In the present embodiment, when the color of the evaluation pattern is only magenta, cyan and yellow are the colors of ink in the ink supplying paths adjacent to the ink supplying path of the ink for printing the evaluation pattern, and thus it can be considered that cyan or yellow are the colors mixed into magenta. Therefore, in the present embodiment, the following two steps will be taken to pick up an image by irradiating the evaluation pattern with illumination light. At a first step, the evaluation pattern is irradiated with illumination light having a color belonging to the symbol R, which is the color complementary to the symbol BG, so as to pick up an image because cyan belongs to the symbol BG in the hue circle shown in FIG. 5 and the hue located diametrically opposite thereto is the symbol R.

The range of hue of the illumination having a color belonging to the symbol R is preferably any of 2.5R, 5R, 7.5R and 10R. At a second step, the evaluation pattern is irradiated with illumination light having a color belonging to the symbol PB, which is the color complementary to the symbol Y, so as to pick up an image because yellow belongs to the symbol Y in the hue circle shown in FIG. 5 and the hue located diametrically opposite thereto is the symbol PB. The range of hue of the illumination having a color belonging to the symbol PB is preferably any of 2.5PB, 5PB, 7.5PB and 10PB. In addition, the first step and the second step can be carried out by changing the sequence.

In the present embodiment, when the color of the evaluation pattern is only yellow, magenta is the color of ink in the ink supplying path adjacent to the ink supplying path of the ink for printing the evaluation pattern, and thus magenta is the color that will be mixed into yellow. The evaluation pattern is irradiated with illumination light having a color belonging to the symbol G, which is the color complementary to the symbol RP, so as to pick up an image because magenta belongs to the symbol RP in the hue circle shown in FIG. 5 and the hue located diametrically opposite thereto is the symbol G. The range of hue of the illumination having a color belonging to the symbol G is preferably any of 2.5G, 5G, 7.5G and 10G.

Next, gradation values are measured at step S303. In a measurement method, lightness is measured for each one of pixels of an image 501 read in the image processing unit 105, which is stored in the arithmetic processing 107.

Next, it is determined at step S304 whether or not the measured lightness value is beyond a predetermined threshold value. The measured lightness value is compared to a preset lightness threshold value. If the measured lightness value is the lightness threshold value or above, the procedure proceeds to step S306 to conduct the determination as a non-defective. Furthermore, if the measured lightness value is the lightness threshold value or below, the procedure proceeds to step S305 to determine that color mixing is generated. In addition, the measured lightness value may be the lowest lightness value of a plurality of pixels.

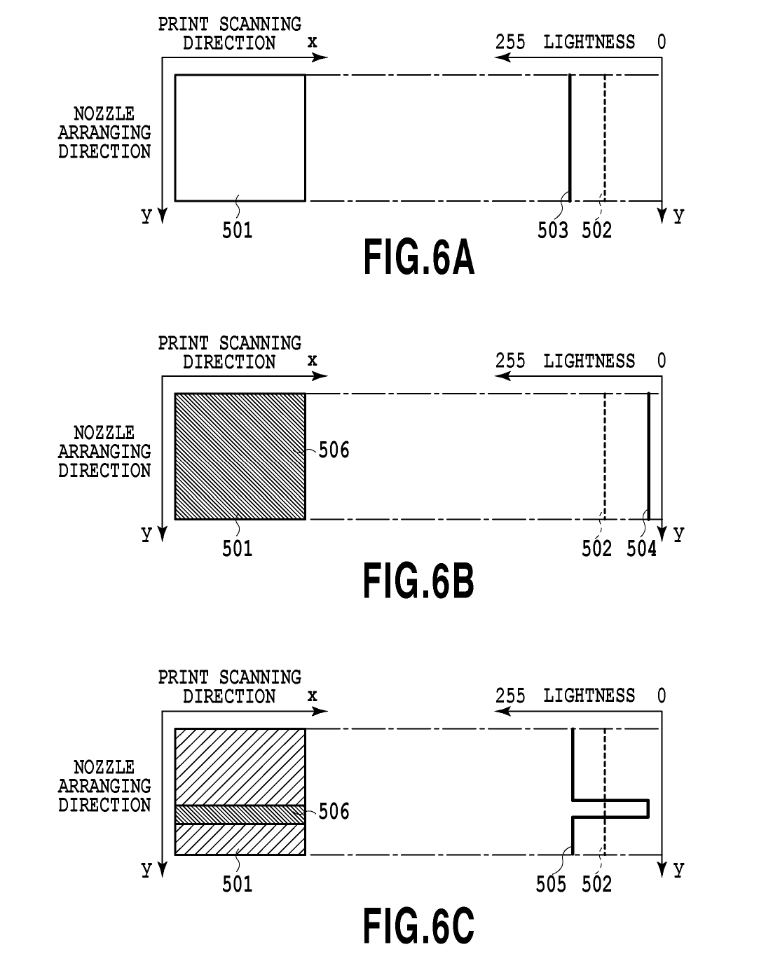

A color mixing inspection method according to the present invention will be described further in detail using FIGS. 6A to 6C. FIGS. 6A, 6B and 6C are schematic diagrams showing three patterns, i.e., no color mixing, color mixing existing therethroughout and streak-like color mixing, respectively, measured by means of a color mixing inspection method according to the present invention. When the printing is done by means of a print head in which color mixing is generated, mixed color ink is ejected from any (or all) of the ink ejection ports, and the mixed color ink is continuously ejected from the ejection port during the printing. More specifically, streaks are formed linearly to the print scanning direction when color mixing is generated, which is generated specifically in inkjet printing. In accordance the fact described above, the generation pattern of color mixing 506 includes color mixing existing therethroughout and streak-like color mixing as in FIGS. 6B and 6C.

In the case where no color mixing is generated as shown in FIG. 6A, the measurement of the lightness by means of the inspection method described above derives a certain lightness value 503 beyond the lightness threshold value. Furthermore, in the case where color mixing is generated as shown in FIGS. 6B and 6C, the measurement of the lightness in a similar way derives the lightness threshold value 502 or below of the lightness value in the case of color mixing existing therethroughout, whereas the lightness threshold value 502 or below of the lightness value in part in the case of streak-like color mixing.

More specifically, if the lightness threshold value 502 is set to be between the lightness value in the case of no color mixing and that in the case of color mixing existing, it is possible to determine the presence of color mixing by taking the lightness threshold value 502 as boundary.

In this manner, the color mixed into the evaluation pattern is limited in light of the structure of the print head. Therefore, the color mixing can be emphatically picked up by irradiating the evaluation pattern with light having a color complementary to the color mixed into the evaluation pattern. This has made it possible to realize a color mixing inspection method for the print head capable of carrying out the inspection for color mixing at low cost for the inspection with high detection ability.

### Second Embodiment

A second embodiment of the present invention will be described below with reference to drawings. In addition, the basic structure of the present invention is same as that of the first embodiment, so that only the characteristic structure will be described below. In the present embodiment, other method will be described in detail which can execute the color mixing inspection with further high detection ability.

First, similar to the first embodiment, step S301 is executed in accordance with the flow of the color mixing inspection method shown in FIG. 3.

Then, the evaluation pattern is illuminated and picked up at step S302. Light is adjusted from that having a color located diametrically opposite thereto in the hue circle shown in FIG. 5, which is the color complementary to the color of ink in the ink supplying path adjacent to ink supplying path of ink for printing the evaluation pattern, to that having a color closer to the tone of the evaluation pattern 401, and then the evaluation pattern 401 is irradiated with the adjusted light. Then, the picked-up image is read in the image processing unit 105.

In the present embodiment, when the color of the evaluation pattern is only cyan, magenta is the ink color in the ink supplying path adjacent to the ink supplying path leading to the ejection port for printing the evaluation pattern, and thus magenta is the color that will be mixed into cyan. In the hue circle shown in FIG. 5, cyan belongs to the symbol BG, and magenta belongs to the symbol RP.

The hue located diametrically opposite to the symbol RP is the symbol G, so that the evaluation pattern is irradiated with illumination light that is adjusted to have a color closer to the symbol PB on the color belonging to the symbol G that is the color complementary to the symbol RP, so as to pick up an image. The range of hue of the adjusted illumination light is preferably any of 10G, 2.5BG and 5BG.

In the present embodiment, when the color of the evaluation pattern is only magenta, cyan and yellow are the ink colors in the ink supplying paths adjacent to the ink supplying path for printing the evaluation pattern, and thus cyan and yellow may be the colors that will be mixed into magenta. Therefore, also in the present embodiment, the following two steps will be taken to pick up an image by irradiating the evaluation pattern with illumination light.

In a first step, magenta belongs to the symbol RP and cyan belongs to the symbol BG in the hue circle shown in FIG. 5. The symbol R is the hue that locates diametrically opposite to the symbol BG, so that the evaluation pattern is irradiated with illumination light that is adjusted to have a color closer to the symbol RP and a color belonging to the symbol BG that is the color complementary to the symbol BG, so as to pick up an image. The range of hue of the adjusted illumination light is preferably any of 10RP, 2.5R and 5R.

In a second step, magenta belongs to the symbol RP and yellow belongs to the symbol Y in the hue circle shown in FIG. 5. The symbol PB is the hue that locates diametrically opposite to the symbol Y, so that the evaluation is irradiated with illumination light that is adjusted to have a color closer to the symbol RP and a color belonging to the symbol PB that is the color complementary to the symbol Y, so as to pick up an image. The range of hue of the adjusted illumination light is preferably any of 10PB, 2.5P and 5P.

In the present embodiment, when the color of the evaluation pattern is only yellow, magenta is the ink color in the ink supplying path adjacent to the ink supplying path for printing the evaluation pattern, and thus magenta is the color that will be mixed into yellow. In the hue circle shown in FIG. 5, yellow belongs to the symbol Y and magenta belongs to the symbol RP. The symbol G is the hue that locates diametrically opposite to the symbol RP, so that the evaluation pattern is irradiated with illumination light that is adjusted to have a color closer to the symbol Y and a color belonging to the symbol G that is the color complementary to the symbol RP, so as to pick up an image. The range of hue of the adjusted illumination light is preferably any of 5GY, 7.5GY and 10GY. Then, step S303 and the subsequent steps are executed in the same way as the first embodiment.

In this manner, the light is shed whose color is adjusted from that is complementary to the hue of mixed color to that is closer to the same type of color of the hue of the evaluation pattern, so that the difference in concentration between the evaluation pattern and the margin is reduced in the picked-up image. This reduces the effect of change in tone on the picked-up image in the case where ejection failure or deflection occurs in the evaluation pattern, so that it is possible to carry out the color mixing inspection at low cost for the inspection with high detection ability.

### Third Embodiment

A third embodiment of the present invention will be described below with reference to drawings. In addition, the basic structure of the present invention is same as that of the first embodiment, so that only the characteristic structure will be described below.

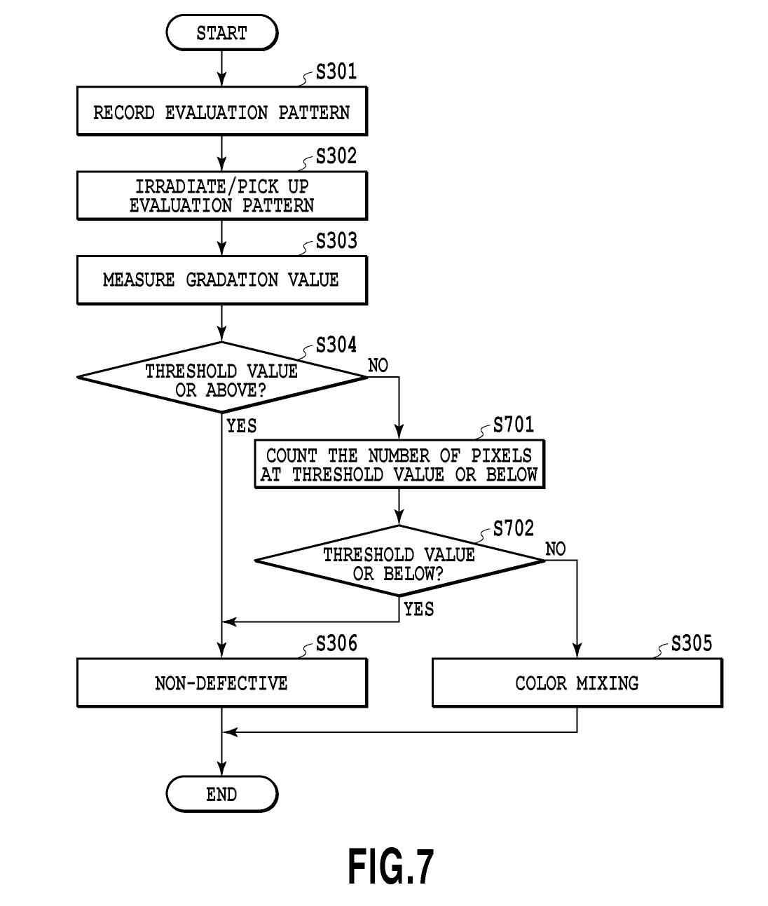

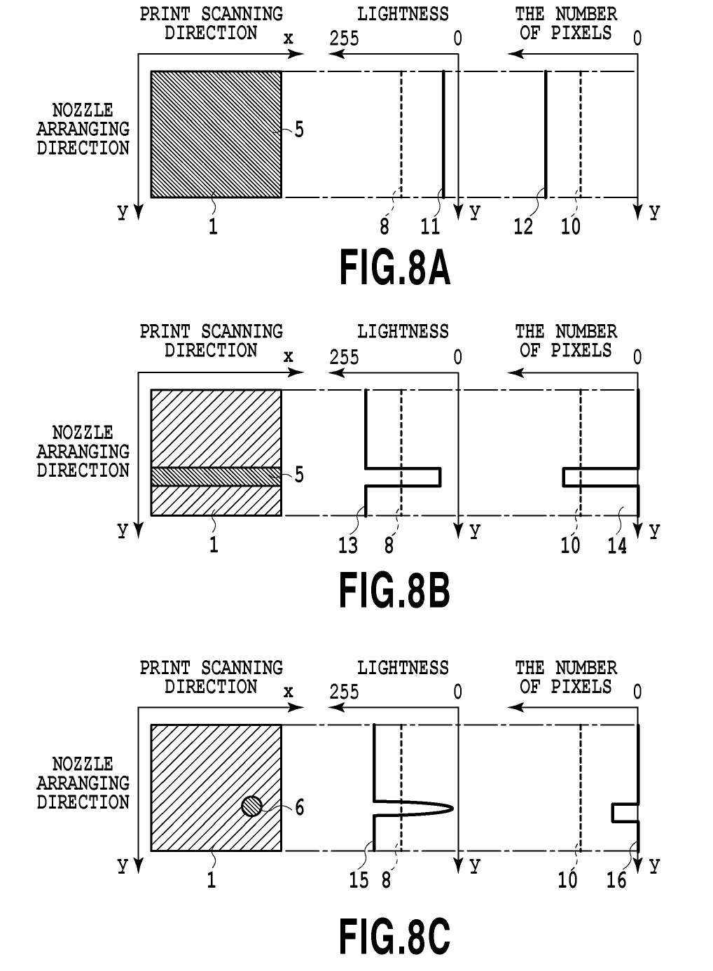

FIG. 7 is a flow chart showing a flow of a color mixing inspection method according to the present embodiment, and FIGS. 8A to 8C are diagrams schematically showing specific examples of the color mixing inspection method according to the present embodiment.

The color mixing inspection method according to the present embodiment will be described below in accordance with the flow chart in FIG. 7. The processes from steps S301 to S304 are executed similarly to the first embodiment.

If the lightness is at the threshold value or below at step S304, the processes at steps S701 and S702 are executed so as to distinguish the color mixing from dust on the print medium. Here, a method for distinguishing the color mixing from dust on the print medium will be described in detail employing FIGS. 8A to 8C.

FIGS. 8A, 8B and 8C are schematic diagrams showing three patterns, i.e., color mixing existing therethroughout, streak-like color mixing and the case of including dust on a print medium, respectively, measured by means of a color mixing inspection method according to the present embodiment. As shown in FIG. 8C, in the case of including dust on the print medium, change in lightness due to dust close resemble that in the case of generating streak-like color mixing in FIG. 8B. The lightness value 15 generates portions having the lightness threshold value 8 or below, and thus it is difficult to discriminate the color mixing from dust only by the lightness value 15.

However, the color mixing is characterized by forming streaks linearly to the printing direction. Therefore, the number of pixels having the lightness threshold value 8 or below in the case where streak-like color mixing is generated becomes larger than the number of pixels having the lightness threshold value of 8 or below in the case where dust exists on the print medium. Then, in the present embodiment, the number of pixels is counted that has the lightness threshold value 8 or below among those having the lightness value 15.

When a color mixing 5 is generated as shown in FIG. 8B, the number of pixels 14 having the lightness threshold value 8 or below increases. In contrast, as shown in FIG. 8C, since dust on the print medium occupies a small area on the print medium, the number of pixels 16 having the lightness threshold value 8 or below decreases. More specifically, there is the difference in the number of pixels having the lightness threshold value 8 or below even if the color mixing has the lightness value equivalent to that of dust, so that presetting a number-of-pixel threshold value 10 makes it possible to distinguish the color mixing from dust taking the number-of-pixel threshold value 10 as boundary.

In the case of color mixing existing therethroughout, all the pixels have the lightness threshold value 8 or below as shown in FIG. 8A, and thus the number of pixels 12 becomes larger than the pixel threshold value 10. In the case of streak-like color mixing, the number of pixels 14 having the lightness threshold value 8 or below increases only in the portion of color mixing, as shown in FIG. 8B. In the case of including dust on the print medium, the number of pixels 16 having the lightness threshold value 8 or below becomes lower than the pixel threshold value 10, as shown in FIG. 8C.

In addition, measured pixels may be grouped in each array in the print scanning direction or the nozzle arranging direction so as to carry out a method of the number-of-pixel counting 701 which is for those having the lightness threshold value 8 or below for each group.

Furthermore, it is possible to distinguish the color mixing from dust by carrying out the number-of-pixel counting 701 which is for those having the lightness threshold value 8 or below for each group even in the case where the total amount of dust is large or there is a fraction of color mixing for one nozzle array.

Furthermore, in the method of the number-of-pixel counting 701 which is for those having the lightness threshold value 8 or below described above, the method has been described which counts the number of pixels having the lightness threshold value or below. However, it is possible to distinguish the color mixing from dust also by means of a method of counting pixels having the lightness threshold value or above.

The measurement method of counting pixels having the lightness threshold value or below has counted the number of pixels having the lightness threshold value or below, i.e., the number of pixels in the color mixing area and the dust area. In contrast, the measurement method of counting pixels having the lightness threshold value or above is the type of counting the number of pixels having the lightness threshold value or above, i.e., the number of pixels in the area including no color mixing. The number of pixels increases when no color mixing is generated, whereas the number of pixels decreases when color mixing is generated.

In the case of dust, the number of pixels is lower than the case of no color mixing, while the number of pixels becoming larger than the case of color mixing. Both the number-of-pixel counting methods can distinguish the color mixing from dust. Nevertheless, considering the fact that the case of no color mixing occurs more frequently, it is advantageous to take the method of counting the number of pixels having the lightness threshold value or below, i.e., the number of pixels in the color mixing area and the dust area, in light of the handling capacity.

As described above, the color mixing is characterized by forming streaks linearly to the printing direction. Therefore, scanning is conducted in the print direction for each pixel in the nozzle arranging direction, and the determination is made by the number of pixels having the smallest concentration value for each scanning and those having the concentration threshold value or below for each scanning. It is thus possible to carry out the color mixing inspection with high accuracy without the influence of dust on the print medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-184309, filed Sep. 5, 2013, which is hereby incorporated by reference herein in its entirety.

What is claimed is:

1. A color mixing inspection method for inspecting an evaluation pattern printed by a first color as a reference for the presence of color mixing of a second color other than said first color, comprising:
an irradiation step for irradiating said evaluation pattern with light having a third color complementary to said second color in which color mixing is supposed to be generated; and
a lightness measurement step for measuring lightness of said evaluation pattern which is irradiated with said light, wherein:
it is provided with a determination step for determining the presence of color mixing by comparing the lightness measured at the lightness measurement step with a predetermined threshold value.

2. The color mixing inspection method according to claim 1, wherein said evaluation pattern is printed by a print head capable of ejecting at least first ink of said first color and second ink of said second color.

3. The color mixing inspection method according to claim 2, wherein said first ink and said second ink are supplied through a first ink supplying path and a second ink supplying path adjacent to each other, the ink supplying paths provided in said print head.

4. The color mixing inspection method according to claim 1, wherein said third color is the color closer to the same type of color of the tone of said evaluation pattern, among colors complementary to said second color.

5. The color mixing inspection method according to claim 1, wherein the measurement of lightness in said lightness measurement step is carried out using an picked-up image of said evaluation pattern so as to count the number of pixels in said image determined to be below said threshold value.

6. A color mixing inspection apparatus, wherein the color mixing inspection method according to claim 1 is used.

7. A print apparatus, wherein the color mixing inspection method according to claim 1 is used.
